(19) United States
(12) Patent Application Publication
(10) Pub. No.: US 2009/0114144 A1
(43) Pub. Date: May 7, 2009

(54) Interactive Bookmark Device

(75) Inventor: David Keefe, Wilton, CT (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: REMARKABLE READING CONCEPTS LLC, Albany, NY (US)

(21) Appl. No.: 12/200,370

(22) Filed: Aug. 28, 2008

Related U.S. Application Data
(60) Provisional application No. 60/984,774, filed on Nov. 2, 2007.

(51) Int. Cl. B42D 9/00

(52) U.S. Cl. 116/234

(57) ABSTRACT

An interactive, novelty bookmark device includes a composite frame having a front and back cover, a magnetic drawing screen mounted within the composite frame, wherein a portion of the drawing screen is accessible through a window in the front cover for receipt and persistent display of information input by a user of the device, a stylus having a magnetic tip and configured for use by the user to input information onto the magnetic drawing screen, an erase lever slidably mounted within the composite frame and having a magnet disposed thereon to selectively erase the magnetic drawing screen, and an engagement appendage mounted to and extending from the frame for releasably securing the interactive bookmark device to associated printed reading material which needs to be bookmarked.

### CROSS-REFERENCE TO RELATED APPLICATIONS

This application claims the benefit under 35 U.S.C. §119(e) of U.S. Provisional Patent Application Ser. No. 60/984,774, entitled “Bookmark Apparatus,” filed Nov. 2, 2007, which is incorporated herein by reference as if set forth herein in its entirety.

### TECHNICAL FIELD

This invention relates generally to children's novelty items and, more particularly, to improved bookmark devices that are interactive and that enable the young reader to take notes, draw, or record information on the device while reading or being read to and, if desired, to preserve such information temporarily between reading sessions.

### BACKGROUND

As children or students learn to read and practice reading with family, teachers, volunteers, or others, they often mark their place in a book with a bookmark. Often, a bookmark is a piece of paper, a dollar bill, or some other convenient item, such as a necklace, decorative cloth, or laminated piece of plastic, that may contain information or decorative elements, but serves no substantive purpose other than to fit between two pages and mark a place in the book. It is fairly common for traditional bookmarks to fall out of place, become lost, or even wear out over time.

Traditional bookmarks also do not offer an easily reusable form of recording the last or next reading page or of enabling the reader to write or draw while reading. Thus, a well established need exists for an improved, interactive bookmark device that records the information such as a reading location that the reader desires to identify and that enables the reader to interact or engage with the bookmark device while reading, being read to, or after reading a book.

### SUMMARY

Briefly described, and according to one embodiment, the present invention is directed toward a bookmark device for preserving information between reading sessions. In particular a bookmark device is provided for preserving information between reading sessions, comprising a composite frame having a front cover and a back cover, a magnetic drawing screen within the composite frame and accessible through a window in the front cover, configured for notation of information related to a reading session, a tethered stylus for notating the information on the magnetic drawing screen, an erase lever for erasing the magnetic drawing screen, and a clip attached to the composite frame, to secure the bookmark device to a book cover.

Another embodiment provides a bookmark device for notation of information between reading sessions, comprising a frame having a front cover and a back cover, a notation component accessible through a window in the front cover, configured for notation of information related to a reading session, an input component for adding the information to the notation component, and a clip attached to the frame to secure the bookmark device to printed reading material.

Yet another embodiment provides a bookmark device for magnification of information during a reading session, comprising, a frame containing a magnification lens, a handle for holding the frame, and a pivot mechanism securing the handle to the frame, whereby during the reading session the handle is rotated and holds the frame for magnification of printed reading material, and between reading sessions the handle serves as a clip to secure the bookmark device to the printed reading material.

In another embodiment, an interactive bookmark device comprises a frame having a front cover and a back cover, a magnetic drawing screen mounted within the composite frame wherein the magnetic drawing screen has a front and a back surface, wherein a portion of the front surface is accessible through a window in the front cover for receipt and persistent display of information input by a user of the bookmark device, a stylus removeably mounted to the composite frame and configured for use by the user, wherein the stylus includes a magnetic tip that inputs information onto the magnetic drawing screen when the magnetic tip is brought into engagement with the front surface of the magnetic drawing screen by the user, an erase lever slidably mounted within the composite frame and having a magnet disposed thereon wherein the magnet erases the magnetic drawing screen when slid along the back surface of the magnetic drawing screen, and a flexible clip mounted on the back cover of the composite frame for releasably securing the interactive bookmark device to another object.

In a feature of this embodiment, the frame is made of composite plastic material. In another feature, the magnetic drawing screen is a magnetophoretic display. In another feature, the drawing screen is configured to glow in the dark using suitable phosphorescent materials.

In another embodiment, a novelty bookmark device comprises a frame having a front cover and a back cover, an interactive display accessible through a window in the front cover, wherein the interactive display is configured to receive and retain information input therein, an input component connected to the frame and configured to provide input to the interactive display in response to actions taken by a user of the novelty bookmark device, and an engagement component mounted to and extending from the frame for releasably securing the novelty bookmark device to printed reading material.

In features of this embodiment, the frame is constructed from at least one of the following materials: a plastic composite, heavy duty paper, lightweight metal. In another feature, the interactive display comprises a display screen selected from the following list: magnetophoretic display, dry erase board, chalk board. Correspondingly, the input component is preferably a marker or stylus, tethered, connected or otherwise to the frame, and has a suitable tip for notating information on the corresponding interactive display. For example, the marker or stylus may be a magnetic stylus, a dry erase marker, or chalk, depending upon which display is chosen. In another feature, the novelty bookmark device further includes a removal component for erasing the information from the interactive display. The removal component is chosen based on the type of display used, for example, a magnet attached to a lever within the frame, or an eraser, independent from or connected to the marker or stylus.

In another feature, the interactive display is a digital display. Correspondingly, the input component for this type of display may be a mechanical stylus (if the digital display is touch sensitive) or a keypad for entering information to be viewed via the digital display.

In another feature, the novelty bookmark device further includes a voice recorder, preferably digital, to receive and record information input or spoken by the user. Correspondingly, the input component would also include a control pad for operating the digital voice recorder—such control pad being mechanically built into the front cover of the device or displayed via software on the digital display itself.

In another feature, the novelty bookmark device optionally includes a magnifying device pivotally mounted to the frame, wherein the magnifying device is configured to magnify the printed reading material for viewing by the user.

In yet another feature, the novelty bookmark device optionally includes a lighting component pivotally mounted to the frame and adapted to provide light onto the printed reading material for viewing by the user.

In further features of the novelty bookmark device, the engagement component comprises a flexible clip for releasably securing the bookmark device to the printed reading material or an appendage extending from the frame for insertion between pages of the printed reading material. In some features, the engagement component is pivotally mounted to the frame. In other features, the engagement component comprises a spring-loaded clip for releasably securing the bookmark device to the printed reading material.

In yet a further embodiment, a novelty bookmark device for magnification of information during a reading session includes a frame containing a magnification lens, a handle for holding the frame, and a pivot mechanism securing the handle to the frame whereby during the reading session the handle is rotated so that the handle holds the frame for magnification of printed reading material, and between reading sessions the handle serves as a clip to secure the bookmark device to the printed reading material.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an exploded view of a bookmark device in accordance with the present invention.

FIG. 2 illustrates one embodiment of a bookmark device according to FIG. 1.

FIG. 3 illustrates another embodiment of a bookmark device according to FIG. 1.

FIG. 4 illustrates the bookmark device of FIG. 1 secured to a book.

FIG. 5A illustrates an alternative embodiment of a bookmark device.

FIG. 5B illustrates an alternative embodiment of a bookmark device.

FIG. 6 illustrates an embodiment of the bookmark device having a digital display.

FIG. 7 illustrates an embodiment of the bookmark device having a voice recorder.

FIG. 8 illustrates an embodiment of the bookmark device having a magnifying lens.

FIG. 9 illustrates an embodiment of the bookmark device having a voice recorder and magnifying lens.

### DETAILED DESCRIPTION OF PREFERRED EMBODIMENTS

Reference is now made in detail to the description of the embodiments of an interactive bookmark device as illustrated in the drawings. The inventions may, however, be embodied in many different forms and should not be construed as limited to the embodiments set forth herein; rather, these embodiments are intended to convey the scope of the inventions to those skilled in the art. Furthermore, all “examples” given herein are intended to be non-limiting.

As will be described herein, the interactive bookmark device of the present invention is usable in a conventional manner for accurately marking the place where a reader has stopped reading within a book, magazine, or other printed material; however, the bookmark device includes other features and functions, such as preserving information written or drawn by the reader until the next reading session or enabling a child to write words or draw pictures while the parent or teacher is reading the book. For example, the page number for the next page to be read can be written on the bookmark device, and then the bookmark device can be clipped to the front cover of the book. Of course, those of skill in the art will readily recognize that other indicia such as figure numbers, pictures, and descriptions of the page that identify the desired location within the book may be written or drawn or input into the display of the interactive bookmark device. Additionally, it should be noted that the bookmark device is designed to be removably clipped to the cover or jacket of a book, workbooks, journals, page(s), to soft cover books, paperbacks, magazines, or other publications, or even to collections of pages within the same.

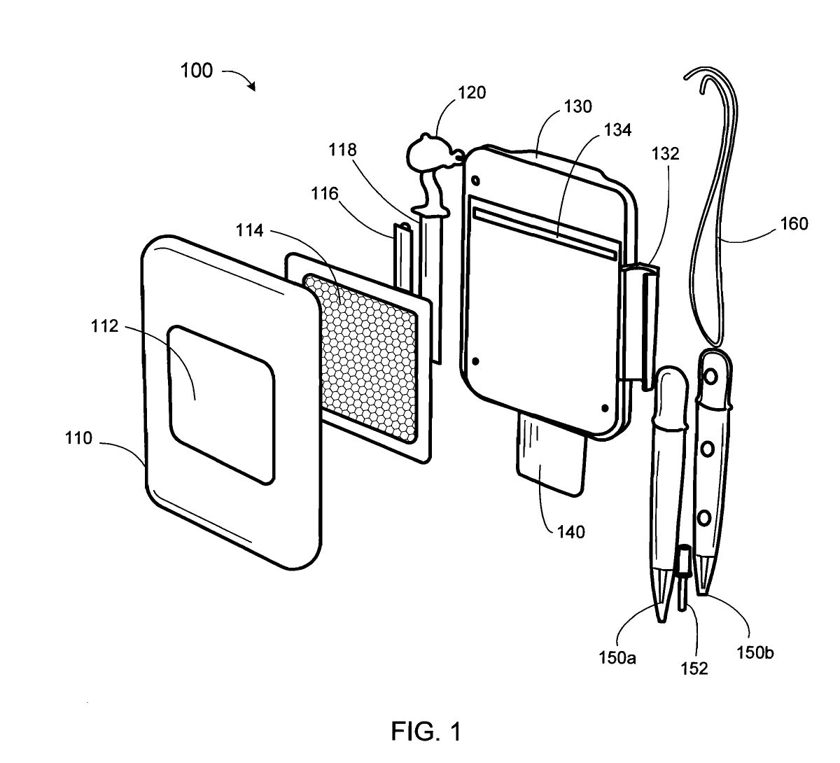

Referring now to the drawings, FIG. 1 is an exploded view of an exemplary interactive bookmark device 100. The bookmark device 100 is preferably constructed from a conventional plastic composite, though other materials, such as heavy duty paper, lightweight metal, or other plastic-type materials are also suitable. The bookmark device 100 has a frame with a front cover 110 and a back cover 130 that encloses a magnetic drawing screen 114 visible through a window 112 in the front cover 110. One example of a magnetic drawing screen 114 is a conventional magnetophoretic display. The display includes conventional magnetic particles suspended in a liquid dispersion medium within a plurality of lattice cells and are preferably combined with dyes to provide contrast with the darker magnetic particles. Such dyes are conventionally white pigment, but they can alternatively be another specific color or phosphorescent or luminescent to enable the materials to be visible (or “glow”) in the dark or in black lighting.

A stylus 150 is secured to the back cover 130 by a tether 160. Writing or drawings may be written on the magnetic drawing screen 114 using the stylus 150. The front stylus half 150a and rear stylus half 150b enclose a magnetic tip 152. The magnetic tip 152 is used to write on the magnetic drawing screen 114 much as a pencil is used with paper, or chalk with a chalk board. The magnetic tip 152 causes the magnetic particles in the magnetophoretic display to be pulled to the front surface of the screen 114 such that they are visible in those areas where the magnetic tip 152 touches the magnetic drawing screen 114. The stylus 150 is designed to be secured or stored in a cradle 132 disposed on a side or back of the device 100.

An erase lever 118 is operable to move a magnet 116 behind the magnetic drawing screen 114 to clear or erase the magnetic drawing screen 114. A decorative handle 120 is optionally attached at the top or end of the erase lever 118. Sliding or pushing the erase lever 118 via the decorative handle 120 causes the erase lever 118 to move along the guide slot 134 and clears the magnetic drawing screen 114 allowing for new writings or drawings.

A flexible clip 140 extends along the back cover 130 of the device 100, is secured generally at the top of the device 100 or at the top of the back cover 130 and is used to secure or mount the bookmark device 100 to other items, such as a cover of a book. As shown, the flexible clip 140 is formed so that internal pressure within the bend of the clip 140 creates force back toward the back cover 130 of the device 100, which enables the device to “clip” or slidably mount onto the cover of the book. Similarly, the flexible clip 140 is usable to secure the bookmark device 100 to other printed items or materials, such as magazines, workbooks, journals, paperbacks, or even collections of pages. The bookmark device 100 is preferably adapted for mounting onto the cover of a book so that the front cover 110 of the bookmark device 100 is visible and the flexible clip 140 is inside the closed book cover; thus, allowing the contents of the magnetic drawing screen 114 to be displayed or viewable even though the bookmark device 100 is mounted to the book. In this manner, a reader may glance at the cover of the book and know the page on which to begin reading. Alternatively, the clip 140 can be inserted into the relevant page where reading previously stopped.

In alternative embodiments (not shown), the clip 140 can be spring-loaded whereby the spring provides the tensions and force between the clip arm and the back cover 130 of the device for clipping onto the book or other printed material. In a further alternative embodiment (not shown), the clip 140 is hinged at the top of the device 100 to enable the main body of the device 100 to extend or pivot at a different angle than the clip. Such pivotal motion is desirable for some commercial applications.

In another alternative embodiment (not shown), the flexible clip is replaced by an appendage that extends below the main body of the device 100. Preferably, the appendage is rigid or semi-rigid and rather than using force or pressure to fixedly “clip” onto a book, is used in more conventional manner, as a bookmark, that slides and fits between pages and is held in place by the pressure of the book (or other printed material) itself. In one variation, the appendage connects at and extends generally from the top of the frame of the device 100, such that the front cover 110 of the bookmark device 100 is visible on top of the book or other printed material when the appendage has been inserted into the book. In another variation, the appendage connects at and extends generally from the bottom of the frame of the device 100, such that the main body or frame of the bookmark device 100 is above the top of the book or other printed material when the appendage has been inserted into the book. In yet a further variation, the bookmark appendage is detachable for placement at either the top or bottom of the frame of the device 100, such that the user is able to select whether the main body or frame of the bookmark device 100 is above the top of the book or other printed material or on top of the cover of the book or other printed material when the appendage has been inserted therein.

In preferred embodiments, the bookmark device 100 can be made or molded into many different forms, shapes, sizes, and designs to accommodate themes such as flowers, insects, animals, sports, cars, cartoon characters, and the like. Third party characters, images, teams, mascots, or logos can be licensed and used to decorate or brand the cover of the device 100.

It will be understood by those of skill in the art that other types of writing or recording devices, or combinations of devices, may also be used in the place of the magnetophoretic display of the magnetic drawing screen 114, including but not limited to blackboard and chalk, dry erase board and marker, digital touch screen, digital display with keypad entry, digital voice recorders, and the like.

The bookmark device 100 can be clipped to a book cover, or alternatively clipped around an entire book, for example. Upon finishing a reading session, the reader can write the number of the page or other identifier such as section, heading, plot detail or the like, to indicate where they were last reading. The page number or other identifier can be written on the magnetic drawing screen 114, thus recording the page location.

After recording the page identifier information, the reader may clip the bookmark device 100 to the front cover of the book to remain until the next reading session. Upon returning to read the book again, the recorded page identifier information is readily available and clearly displayed through the window in the magnetic drawing screen 114. (In a school or other teaching environment, a teacher, parent or other supervisor can check the book to inspect reading progress.) The recorded page information can then be cleared for future use by activating the erase lever 118. Upon finishing the new reading session, the reader simply activates the erase lever 118 to clear the previous entry and can then write a new page number on a clear drawing screen.

It should also be noted that the magnetic drawing screen 114 or other display may alternatively be made large enough to include space for notes to be entered by the teacher, parent, or other supervisor. Of course, the reader may enter words, symbols, letters, phrases or anything else they choose to draw on the magnetic drawing screen 114.

Some benefits of the bookmark device 100 are ease of use, as well as not losing their place in the book, thus allowing readers to finish books without backtracking. The bookmark device 100 also encourages interactive reading with parents and teachers. Further, the bookmark device may involve writing numbers, words, letters, or even comments and is educational in reading, writing, and math. It should also be noted that the bookmark device 100 may include a variety of themes and designs which can make reading more fun.

It should also be noted that the bookmark device 100 may be provided with processors, data entry, transmission and other components for using the bookmark device 100 with computer games, on a local computer, and network games such as Internet accessible games, for example. Such uses can involve the content of the book, tracking reading time, tracking number of pages read, or other methods for tracking progress and development.

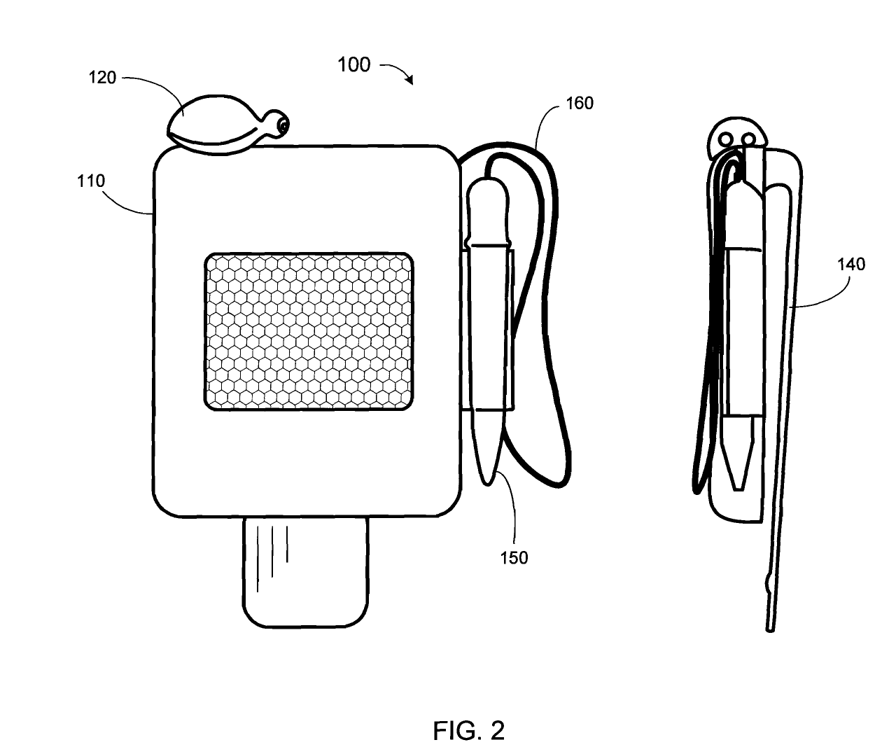

FIG. 2 illustrates a front and side view of the interactive bookmark device 100 shown and described in FIG. 1. As shown, the decorative handle 120 of the erase lever 118 is at the top of the bookmark device 100 and is adapted to slide across the top of the front cover to erase the magnetic drawing screen 114. Those of skill in the art will readily understand that the erase lever 118 may be oriented in other manners according to design choice so long as the motion of the erase lever 118 causes the magnet 116 to pass across or behind the drawing screen and erase or clear the magnetic drawing screen 114. The stylus 150 is tethered via the stylus cord or tether 160 to the back cover 130 of the bookmark device 100 and is mountable in the cradle 132 located at the side of the bookmark device 100.

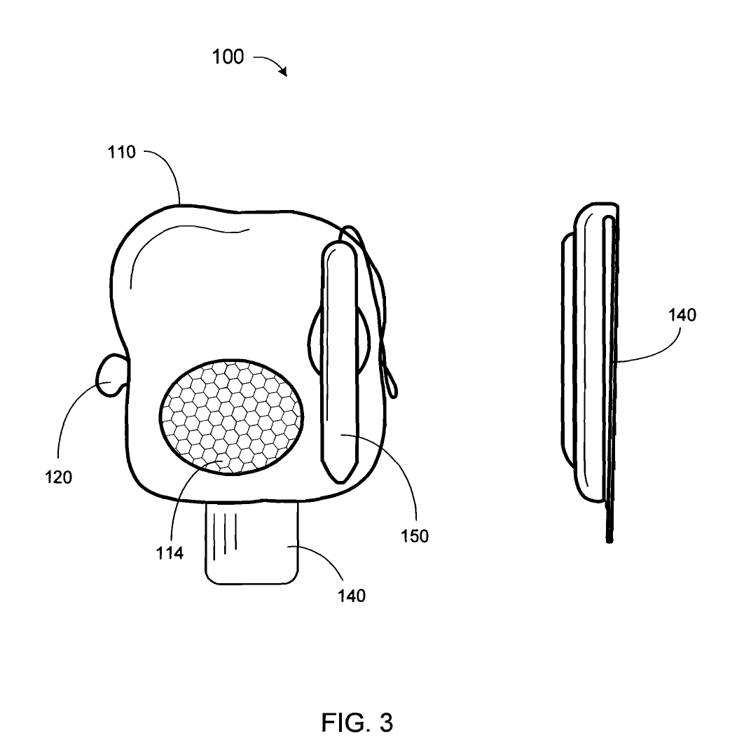

FIG. 3 illustrates both a front view and a side view of an alternative embodiment of the interactive bookmark device 100. In this embodiment, the decorative handle 120 of the erase lever 118 is on a side of the bookmark device 100 and slides vertically along the side of (rather than horizontally across the top of) the interactive bookmark device 100 to erase the magnetic drawing screen 114. Also in this embodiment, the cradle 132 is shown mounted to the front cover 110 rather than to the side of the device 100.

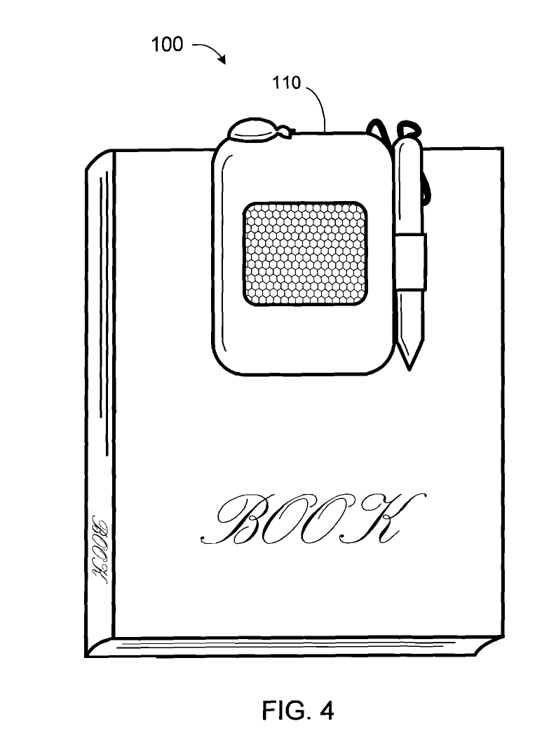

FIG. 4 shows the bookmark device 100 of FIG. 1 secured to the front cover of a book. The body or main housing of the bookmark device 100 slides over the front cover of the book so that the magnetic drawing screen is visible at a glance. The flexible clip 140 portion of the device 100 slides down behind the front cover to hold the bookmark device 100 securely in place on the book cover.

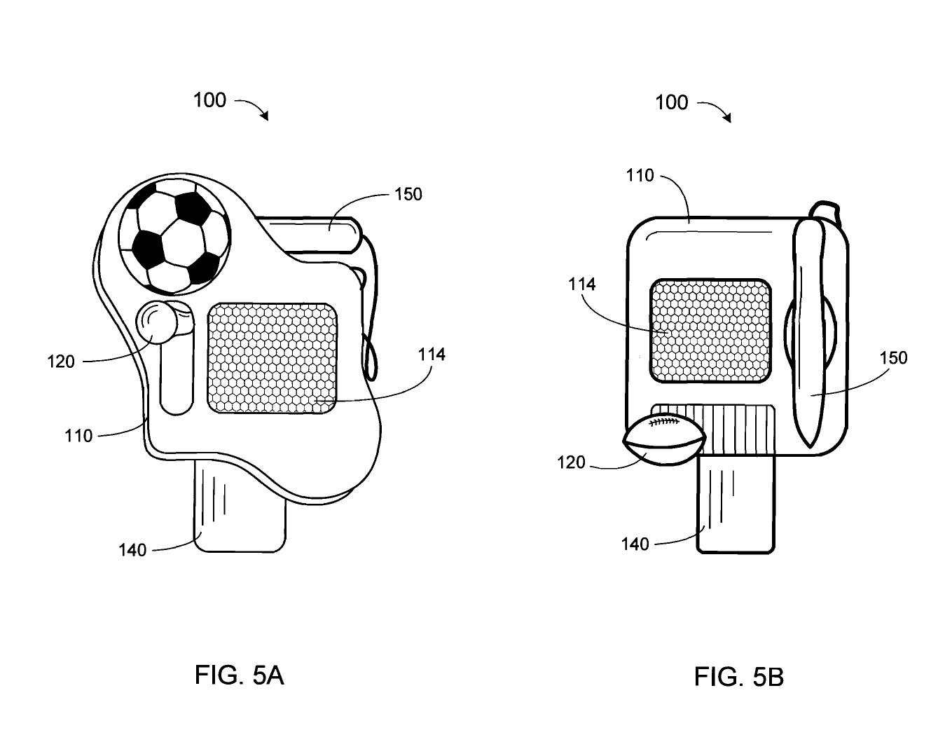

FIG. 5A illustrates an alternative embodiment of the bookmark device 100 with the body of the interactive device having a visually pleasing or hand-ergonomic shape. A theme, symbol, character or logo is placed on the face of the front cover 110. In this illustration, a soccer ball design is provided. Further, the decorative handle 120 has a ball shape, which continues the theme or design of this version of the interactive device 100, and extends through and out from the front cover. In this alternative embodiment, the stylus 150 is secured to the cradle 132, which, in this configuration, is a channel formed between the front and back covers or within a chamber formed in the front or back covers at the top of the bookmark device 100.

FIG. 5B illustrates another alternative embodiment of the bookmark device 100 having another variation in the location of the decorative handle 120 and erase lever 118. The decorative handle 120 has a football shape, is located at the bottom of the front cover 110, and is attached to an erase lever 118 that moves left to right along a simulated football field to clear the magnetic drawing screen 114. The stylus 150 is designed to snap into place in a cradle 132 on the face of the front cover 110 of the bookmark device.

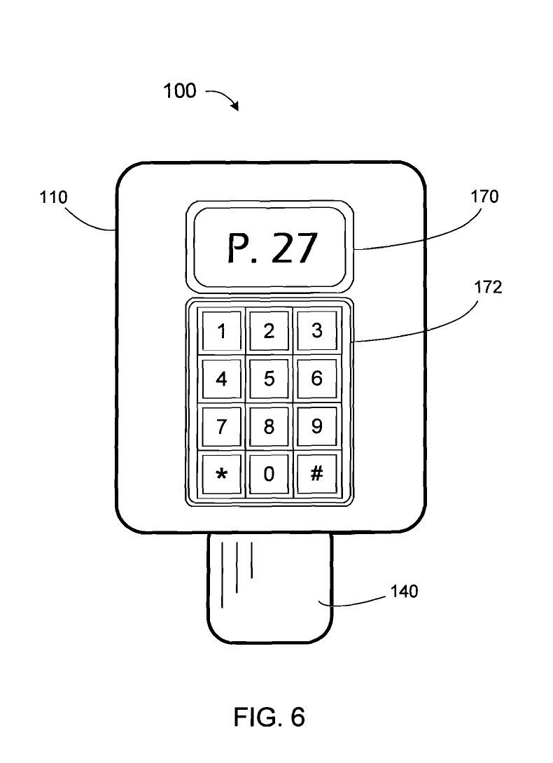

FIG. 6 illustrates another embodiment of the bookmark device 100 having a digital or electronic display rather than a magnetophoretic display. The digital display 170 is visible through a window in the front cover 110 of the bookmark device 100 and provides a readout or display indicating the page number or other information entered by the user. The page number or other information is entered via a keyboard display 172 that includes entry keys for numbers and other symbols. Preferably, the user can enter numeric data or toggle to text entry in conventional manner. While this embodiment illustrates data entry through a conventional telephone keypad display 172, it will be readily apparent to one skilled in the art that other types of data entry pads, including conventional alphanumeric keypads, can be substituted therefor.

After entering the page identifier or other information, the reader may clip the bookmark device 100 to the front cover of the book to remain until the next reading session. Upon returning to read the book again, the recorded page identifier information is readily available and clearly displayed through the window in the digital display 170.

Although not shown, in this embodiment, the interactive bookmark device 100 is preferably battery or solar powered, and either includes a power switch to turn the device on or off or is responsive to movement of the device or touch on the keypad 172.

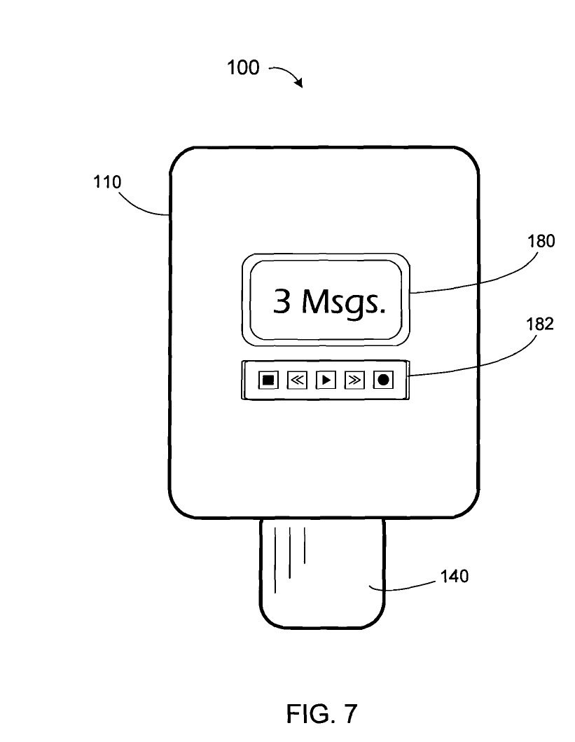

FIG. 7 illustrates another embodiment of the bookmark device 100 having a digital voice recorder. A message display 180 is visible through a window in the front cover 110 of the bookmark device 100 and provides an indication that a message or messages have been recorded. A control 182 enables the user to record, pause, play, stop, delete, or scroll through messages in conventional manner. In some embodiments, only one message is storable and recordation of a new message erases the prior message. In other embodiments, more than one message can be recorded and accessed at a later time.

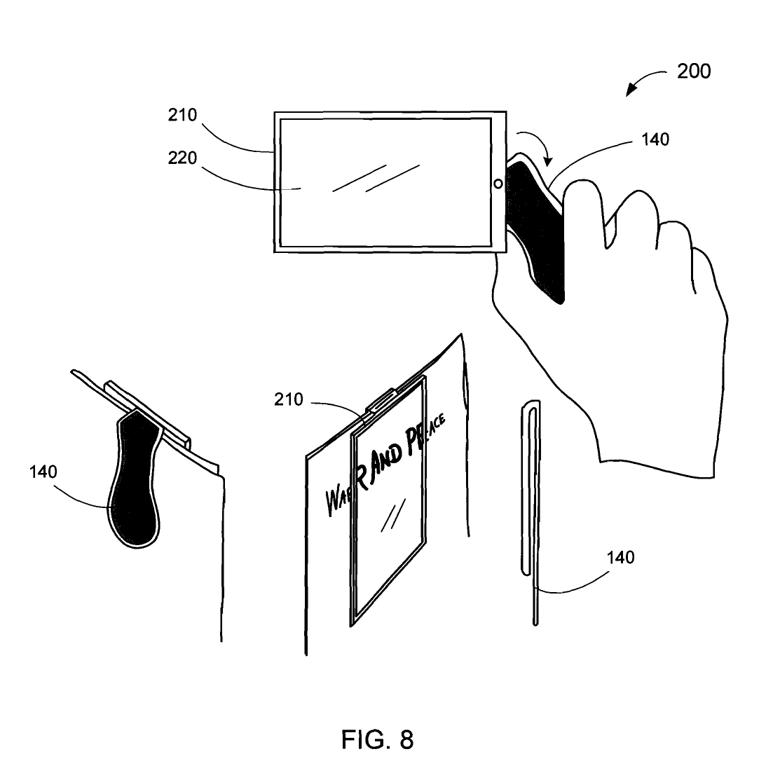

FIG. 8 illustrates an embodiment of a magnifying bookmark device 200 having a magnifying lens. A magnifying lens 220 is enclosed within the frame 210 which is secured to the flexible clip 140 via a pivot mechanism. Any type pivot mechanism may be used that allows the flexible clip 140 to rotate so that the magnifying lens 220 can be used to view text or other images on a printed page. The rotated flexible clip 140 functions as a handle to hold the magnifying lens 220 for viewing the page. The magnifying bookmark device 200 is clipped to a book so that magnifying lens 220 marks the page for reading.

As will be appreciated by those skilled in the art, the magnifying lens 220 of FIG. 8 is easily adaptable for combination with any of the interactive bookmark devices 100 previously described. For example, a magnifying lens 220 can be added to a bookmark device 100 with a magnetic drawing screen 114, with a digital display 170, or with a digital voice recorder 182. Further, a variety of magnifying lens strengths may be incorporated depending upon the desired strength of magnification.

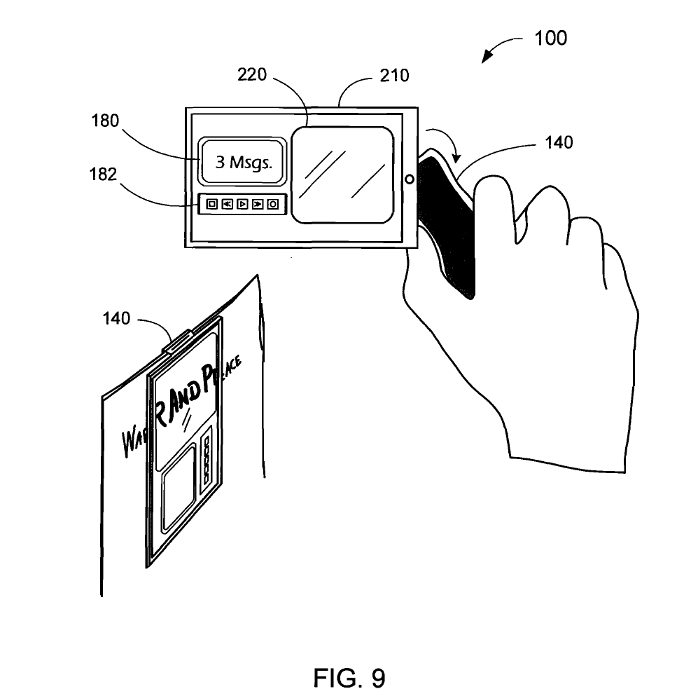

FIG. 9 illustrates an embodiment of the bookmark device 100 having a digital voice recorder 182 and a magnifying lens 220. The flexible clip 140 is secured to the frame 210 via a pivot mechanism that allows the flexible clip 140 to rotate and function as a handle for use of the magnifying lens 220.

As above, a message display window 180 is visible through a window in the front cover 110 of the bookmark device 100 and provides an indication that a message or messages have been recorded. The control 182 enables the user to record, pause, play, stop, delete, or scroll through messages in conventional manner.

As described above, upon recording the page identifier information, the reader may clip the bookmark device 100 to the front cover of the book to remain until the next reading session. Upon returning to read the book again, the message indicator information is readily available and clearly displayed through the window in the message display window 180.

Additionally, it is envisioned that any of the interactive bookmark devices 100 described herein can further include a lighting device such as, for example, a miniature flashlight, or other portable lighting device, that can be used to illuminate a page for reading in limited light environments.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An interactive bookmark device comprising:
a composite frame having a front cover and a back cover;
a magnetic drawing screen mounted within the composite frame wherein the magnetic drawing screen has a front and a back surface, wherein a portion of the front surface is accessible through a window in the front cover for receipt and persistent display of information input by a user of the bookmark device;
a stylus removeably mounted to the composite frame and configured for use by the user, wherein the stylus includes a magnetic tip that inputs information onto the magnetic drawing screen when the magnetic tip is brought into engagement with the front surface of the magnetic drawing screen by the user;
an erase lever slidably mounted within the composite frame and having a magnet disposed thereon wherein the magnet erases the magnetic drawing screen when slid along the back surface of the magnetic drawing screen; and
a flexible clip mounted on the back cover of the composite frame for releasably securing the interactive bookmark device to another object.

2. The interactive bookmark device of claim 1, wherein the magnetic drawing screen is a magnetophoretic display.

3. A novelty bookmark device, comprising:
a frame having a front cover and a back cover;
an interactive display accessible through a window in the front cover, wherein the interactive display is configured to receive and retain information input therein;
an input component connected to the frame and configured to provide input to the interactive display in response to actions taken by a user of the novelty bookmark device; and
an engagement component mounted to and extending from the frame for releasably securing the novelty bookmark device to printed reading material.

4. The novelty bookmark device of claim 3, wherein the frame is constructed from at least one of the following materials: a plastic composite, heavy duty paper, lightweight metal.

5. The novelty bookmark device of claim 3, wherein the interactive display comprises a display screen selected from the following list: magnetophoretic display, dry erase board, chalkboard.

6. The novelty bookmark device of claim 5, wherein the input component is a tethered marker having a suitable tip for notating information on the interactive display.

7. The novelty bookmark device of claim 6, wherein the tethered marker is selected from the following list: magnetic stylus, dry erase marker, chalk.

8. The novelty bookmark device of claim 6, further comprising a removal component for erasing the information from the interactive display.

9. The novelty bookmark device of claim 3, wherein the interactive display is a digital display.

10. The novelty bookmark device of claim 9, wherein the input component is a keypad for entering information to be viewed via the digital display.

11. The novelty bookmark device of claim 3, further comprising a digital voice recorder to receive and record information input by the user.

12. The novelty bookmark device of claim 11, wherein the input component further comprises a control pad for operating the digital voice recorder.

13. The novelty bookmark device of claim 3, further comprising a magnifying device pivotally mounted to the frame, wherein the magnifying device is configured to magnify the printed reading material for viewing by the user.

14. The novelty bookmark device of claim 3, further comprising a lighting component pivotally mounted to the frame and adapted to provide light onto the printed reading material for viewing by the user.

15. The novelty bookmark device of claim 3, wherein the engagement component comprises a flexible clip for releasably securing the bookmark device to the printed reading material.

16. The novelty bookmark device of claim 3, wherein the engagement component comprises an appendage extending from the frame for insertion between pages of the printed reading material.

17. The novelty bookmark device of claim 3, wherein the engagement component is pivotally mounted to the frame.

18. The novelty bookmark device of claim 3, wherein the engagement component comprises a spring-loaded clip for releasably securing the bookmark device to the printed reading material.

19. The novelty bookmark device of claim 3, wherein the interactive display comprises a display screen that glows in the dark.

20. A novelty bookmark device for magnification of information during a reading session, the bookmark device comprising:
a frame containing a magnification lens;
a handle for holding the frame; and
a pivot mechanism securing the handle to the frame,
whereby during the reading session the handle is rotated so that the handle holds the frame for magnification of printed reading material, and between reading sessions the handle serves as a clip to secure the bookmark device to the printed reading material.
